(19) United States
(12) Patent Application Publication
(10) Pub. No.: US 2026/0244721 A1
(43) Pub. Date: Aug. 20, 2026

(54) ADAPTIVE RISK-BASED CHALLENGE SYSTEM USING CONFORMAL UNCERTAINTY CALIBRATION

(71) Applicant: Microsoft Technology Licensing, LLC, Redmond, WA (US)

(72) Inventors: Suyash GUPTA, Sunnyvale, CA, USA, CA (US); Rohit Kumar PATRA, Brooklyn, NY (US); Jack Elie GINDI, New York, NY (US)

(21) Appl. No.: 19/058,564

(22) Filed: Feb. 20, 2025

(51) Int. Cl. G06F 21/31; G06F 21/46

(52) U.S. Cl. CPC G06F 21/31; G06F 21/46; G06F 2221/2103

(57) ABSTRACT

Aspects of the disclosure include methods and systems for an adaptive risk-based challenge system. A method includes generating challenge features for challenges and generating user features for a user device. The method includes generating, based on the challenge features and the user features, suitability scores for the challenges where the subset of the challenges is selected to meet a suitability threshold, and building, based on the suitability scores, a subset of the challenges. The method includes selecting a challenge from the subset of the challenges and presenting the challenge to the user in order to receive a response, where access to a protected system is determined in accordance with the response.

### INTRODUCTION

The subject disclosure relates to machine learning, networks, online platforms, and security systems, and specifically to adaptive risk-based challenge system for platform-wide friction management using conformal uncertainty calibration.

### A BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram for dynamically providing an adaptive risk-based challenge system for platform-wide friction management using conformal uncertainty calibration in order to grant or deny access to protected systems in accordance with one or more embodiments;

FIG. 2 depicts a flow diagram of a method for dynamically executing an adaptive risk-based challenge system for platform-wide friction management using conformal uncertainty calibration in order to grant or deny access to protected systems in accordance with one or more embodiments;

FIG. 3 depicts a block diagram for labeling data and training a model to predict challenges for users in accordance with one or more embodiments;

FIG. 4 depicts a Table utilized to generate labeled data for challenges in accordance with one or more embodiments;

FIG. 5 depicts a Table utilized to generate labeled data for challenges in accordance with one or more embodiments;

FIG. 6 depicts a block diagram of an example of a low security risk user requesting and gaining access to digital resources in response to successfully solving a challenge in accordance with one or more embodiments;

FIG. 7 depicts a block diagram of an example of a high security risk user requesting and failing to gain access to digital resources in response to not solving a challenge in accordance with one or more embodiments;

FIGS. 8A and 8B depict an example procedure for conformal calibration in order to identify a threshold for suitability scores in a challenge set in accordance with one or more embodiments;

FIG. 9 depicts a block diagram of a neural network in accordance with one or more embodiments;

FIG. 10 depicts a block diagram of a transformer-type model implementation in accordance with one or more embodiments;

FIG. 11 depicts a flowchart of a method in accordance with one or more embodiments; and

FIG. 12 depicts a block diagram of a computer system according to one or more embodiments.

The diagrams depicted herein are illustrative. There can be many variations to the diagrams or the operations described therein without departing from the spirit of this disclosure. For instance, the actions can be performed in a differing order or actions can be added, deleted or modified.

In the accompanying figures and following detailed description of the described embodiments of this disclosure, the various elements illustrated in the figures are provided with two or three-digit reference numbers. With minor exceptions, the leftmost digit(s) of each reference number corresponds to the figure in which its element is first illustrated.

### DETAILED DESCRIPTION

### Overview

In computer security, challenge-response authentication is a set of protocols used to protect digital assets and services from unauthorized users, programs, or activities. While challenge-response authentication can be as simple as a password, it can also be as dynamic as a randomly generated request. Challenge-response authentication is a cybersecurity tool to secure sensitive information, identify suspicious behavior, and/or block certain programs.

In an example, challenge-response authentication is composed of two basic components: a question and a response. A challenge is a question or inquiry that requires a response as the answer. The goal of the question or challenge is to require a response that authorized users will know or can answer. Users that successfully answer the question are allowed access to whatever digital materials the challenge-response authentication mechanism is safeguarding.

The goal of challenge-response authentication is to limit the access, control, and use of digital resources to only authorized users and activities. In some cases, users are not the only ones sending requests, and sometimes bots (e.g., automated software) send request to access the digital resources. If a mobile application or a malicious software (malware) program requests access to a set of protected digital assets and services, it can be denied by integrating challenge-response authentication.

In the existing registration defense ecosystem, challenges are assigned using a linear scale based on Auryn scores globally across all users. Auryn scores are risk scores produced by a real-time registration defense system. The real-time registration defense system can use a model (e.g., a machine learning model) to calculate a risk score (e.g., between 0 and 1) using factors associated with a user device. The threshold selection exercise is fairly complex, because at a high level, the threshold selection process makes quite a few significant assumptions about action rates, false positive rate (FPR), precision, and recall in order to choose the threshold. If those assumptions are violated in production, there is no guarantee that the threshold that is selected will be optimal. The threshold selection exercise might be only used to choose a few candidate thresholds. The system then performs an A/B test, which is also known as split testing, for the different proposed thresholds and observes that the production impact is acceptable before ramping/using one of the candidate thresholds to treat all traffic. This threshold scale suffers from limitations: 1) Assumptions: Since the existing method relies on significant assumptions and does not account for how the thresholds affect each other, there is uncertainty about whether the action rates, precision, recall, and false positive rate (FPR) will behave as predicted. The action rate is the rate at which the system takes an action on users regarding a challenge. For example, if the system is setup such that anyone receiving a risk score above 0.01 receives a challenge, the action rate is much higher than if the system only acts on anyone receiving a risk score of 0.9. The FPR is the rate at which non-abusive accounts are inadvertently treated as abusive. In an example case, this means that a low risk user's registration has been blocked by being issued a challenge and not solving it. Action rates and FPR are two of the example metrics considered when selecting thresholds. Before a threshold is selected, the machine learning model produces risk scores. Once the system has risk scores between 0 and 1, the system selects three thresholds t1, t2, and t3 such that (for a risk score): a) between 0 and t1, the user gets no challenge; b) between t1 and t2, the user gets one type of challenge (the “easier” one); c) between t2 and t3, the user gets another type of challenge (the “harder” one); and d) between t3 and 1, the user's registration is blocked. The thresholds t1-t3 are selected during the selection threshold process. Where a user falls on that threshold scale is determined by the risk score that the model produces when the user registers. The thresholds that are selected might also impact the model's statistical performance metrics such as precision, recall, and/or FPR. Therefore, in the threshold selection process, one might, for example, try one combination that emphasizes achieving a desired (estimated) precision, another that prioritizes (estimated) recall, and a third that tries to keep (estimated) FPR below a certain level. Because of this uncertainty in estimating these quantities, it would be difficult to effectively adapt it to a larger array of available challenges in the future. 2) Inflexibility: The current threshold selection method establishes a linear scale, which implies a single difficulty ordering on challenges that applies to all requests. It neither adapts to new patterns of behavior, nor does it take into account that for certain actors, certain challenges might be more difficult than others. 3) No exploration: In order to be able to improve the system, it would be helpful to explore assigning non-optimal challenges in order to learn how users respond to them. Under the current system, there is no exploration mechanism but rather the system selects a single challenge from the challenges based on the threshold.

The present disclosure addresses various technical problems. There are technical problems of how to achieve security of protected systems in an efficient manner and how to provide an adaptable security mechanism that achieves better results by selecting challenges based on factors associated with the users. One or more embodiments provide a technical solution to achieve security of protected systems by selecting verification challenges dynamically during registration, login, and other key parts of the platform, tailoring the amount of computational work needed to generate the verification challenge according to the Internet protocol (IP) address, user device behavior, geographic location, etc. In the case of an IP address (along with other factors) indicating a higher security risk for a user, a two-factor authentication verification challenge may be generated; whereas for an IP address (along with other factors) indicating a lower risk for a user, a verification challenge such as a CAPTCHA or no challenge may be used where the amount of computational work to generate the challenge is less.

In one or more embodiments, a method includes selecting a verification challenge in accordance with the security risk of the user, challenging the user device of the user with the selected challenge, and in response to the user failing the challenge, triggering an automated action with respect to the user device such as isolating the user device, blocking the user device for registering/logging in, preventing (or denying) the user device access to a protected system, etc. In response to the user device of the user passing the challenge, granting the user device access to the protected system.

In applications managing sensitive data or transactions, it is important to verify user authenticity during key actions such as registration, password resets, logins, payments, etc. Challenges, such as CAPTCHA, email verification, or phone verification, are common tools to filter out malicious users. However, simply offering the same challenge to every user of certain risk levels leads to two issues:

1) Security versus Usability: High-risk users (e.g., likely inauthentic or automated) need difficult challenges to deter or, in the case of extremely risky users, prevent registration altogether. Conversely, low-risk, legitimate users should face simpler (or no) challenges to streamline their user experience and improve the likelihood of successful registration. A risk score is a measure of riskiness for a user, and the risk score may range from 0 to 1, based on a variety of factors. A high risk score denotes a higher risk of future suspicious behavior or non-compliant actions by a user, while a low risk score denotes future normal behavior or compliant actions by a user. In one or more embodiments, low-risk users may have a risk score of 0.5 or less (e.g., 50% or less), while high-risk users may have a risk score greater than 0.5 (e.g., greater than 50%). In one or more embodiments, the risk score may not be explicit but can be learned or inferred based on user features of a user, where the user features are similar to those of low-risk users or high-risk users. Similarity in this context can be determined as a distance measure between embeddings of the user features in an embedding space being below a predetermined threshold.

2) Dynamic Challenge Assignment: The difficulty of challenges should adapt based on the user's attributes and risk profile. In accordance with one or more embodiments, the system is configured to simultaneously assess each challenge's effectiveness for different users and align challenge difficulty with the user's risk score (e.g., a continuous value from 0 to 1). In the present disclosure, this approach presents a complex, dual learning problem that involves learning to rank challenges by difficulty per user and learning which challenge to send to the user based on risk score (or user features), according to one or more embodiments. With respect to learning to rank challenges by difficulty per user, the system can identify which challenges are easier or harder for each user, as different users might struggle with different challenges depending on their background, behavior, and risk profile. With respect to learning which challenge to send to the user based on risk score, after ranking challenges, the system decides which specific challenge to present to a user based on their risk score. For instance, a user with a risk score close to 1 should receive the hardest challenge for them, while a user with a score near 0 should receive the easiest challenge.

Achieving both tasks requires an adaptive approach that not only assesses user risk but also tailors challenge assignments to maximize security for high-risk users and usability for low-risk user according to one or more embodiments. Instead of approaching this as two separate problems (e.g., risk modeling and challenge selection), the present disclosure takes a strategic approach of reformulating this as a classification problem or classification task. In order to label registration requests (or any type of requests), the present disclosure requires some measure of riskiness of the users. For example, the present disclosure can accomplish this with a standalone registration risk model, and the standalone registration risk model assigns each user a risk score, ranging from 0 to 1, based on a variety of factors like IP address patterns, account history, geographic location, background, user device behavior, etc. A higher score signals a higher risk of future suspicious behavior. When a user receives a challenge, the system observes whether the user solves the challenge. The response variable records this outcome of the challenge: 1) For risky users with high risk scores (e.g., at registration) or who are restricted, a failure to submit or complete the challenge is recorded as 1 (e.g., indicating that the challenge successfully deterred a potentially suspicious user), while a successful completion is recorded as 0 (e.g., sending a bad challenge because the objective is to deter risky users). 2) For non-risky users with low risk scores at registration or who are currently non-restricted, a successful challenge completion is recorded as 1 (e.g., indicating that the challenge did not block a legitimate user), while failure or abandonment is recorded as 0 (e.g., indicating that the challenge blocked a legitimate user or low-risk user).

According to one or more embodiments, the present disclosure utilizes a challenge ranker model, a conformal inference model, and a challenge selector. The challenge ranker model is trained to generate a suitability score for a (user, challenge) pair. The conformal inference model is trained to receive a ranking of challenges by suitability scores and produce a set of challenges that contain a suitable challenge with a user-specified probability. Once the suitability scores are generated for the challenges, the set represents a smaller group taken from the challenges, such that the set contains a suitable challenge with a user-specified probability. The challenge selector is configured to receive the prediction set and select a challenge from the set to be sent to the user device of the user. Further details are discussed herein.

### Detailed Embodiment

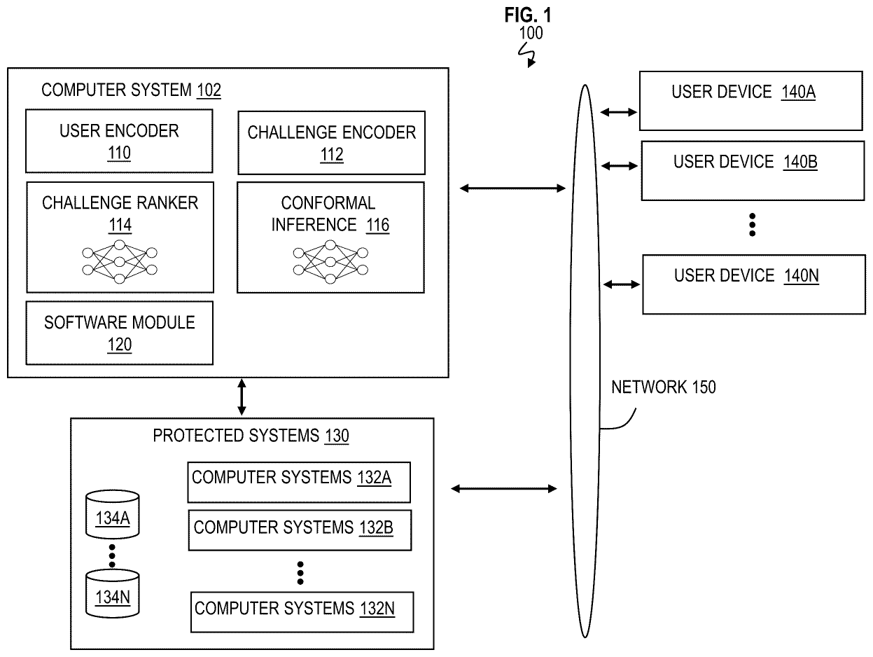

FIG. 1 depicts a block diagram of an example system 100 configured to dynamically provide an adaptive risk-based challenge system for platform-wide friction management using conformal uncertainty calibration in order to grant or deny access to protected systems, according to one or more embodiments. The system 100 includes a computer system 102 that can be representative of numerous computer systems connected in a distributed manner. The computer system 102 is dynamic in that it operates in real-time or near-time in response to receiving a request to access, for example, protected systems. As will be described in further detail herein, the computer system 102 can include and/or access a user encoder 110, a challenge encoder 112, a challenge ranker model 114, and a conformal inference model 116. Although not shown, the computer system 102 can include various software and hardware components including software applications (apps) for communicating over a network 150 as understood by one of ordinary skill in the art.

The computer system 102 is configured to communicate over a network 150 with many different computer systems, such as a user device 140A, a user device 140B, through a user device 140N. The user device 140A, the user device 140B, through the user device 140N can generally be referred to as user devices 140.

A user of the user devices 140 can request access to online data and/or services, which require access to one or more protected systems 130. There are numerous online services in various sectors as understood by one of ordinary skill in the art. Online services can refer to computer services and/or digital services provided over a network communication such as the network 150. Examples of online services may include social networking/media services, messaging services, work services (e.g., remote access to computer networks of employers), email services, music services, media streaming services, financial investment services, gaming services, and the like. It should be appreciated that the protected systems 130 can be representative of any type of networks, online platforms, etc., and are not meant to be limited.

The computer system 102 is configured to present a challenge that must be passed by the user of the user device 140 in order for the request to be granted, for example, to grant access to the protected systems 130. After being challenged and passing the challenge, the user of the user device 140 is granted access in accordance with the request. If the challenge is not passed, the user is denied access. The challenge for accessing a requested service or system is part of a security mechanism used to verify the identity of a user or entity attempting to gain access. This is often part of a challenge-response authentication protocol. In this context, the “challenge” is a question or task that the user must correctly answer or complete to prove their identity, to prove that they are human, etc. Examples of challenges can include a CAPTCHA, a question, password entry, two-factor authentication (2FA), biometric verification, etc.

The user devices 140 may be representative of an electronic device such as any type of personal user device. The user device can be a personal computer or laptop. The user device can be a mobile device such as a cellular phone or tablet, or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, smart clothing, and many others.

The network 150 can be a wired and/or wireless communication network, and the communication network includes a telecommunications network, the public switched telephone network (PTSN), voice over IP (VOIP) network, etc. The communication network includes cellular networks, satellite networks, etc.

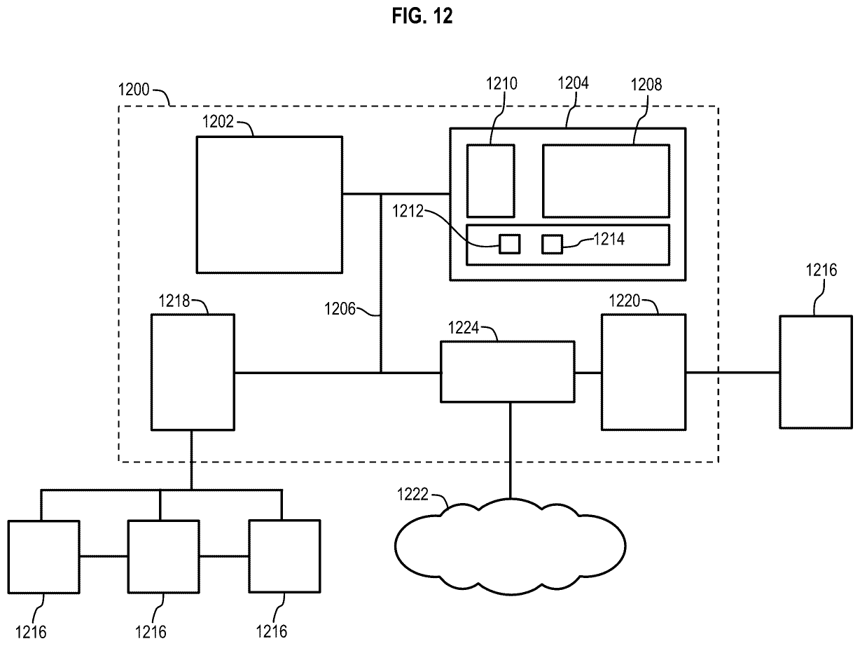

The computer system 102, the user devices 140, the protected systems 130, etc., can include functionality and features of the computer system 1200 in FIG. 12 including various hardware components and various software applications such as software that can be executed as instructions on one or more processors in order to perform actions according to one or more embodiments of the invention. The computer system 102 and software module 120 can include, be integrated with, and/or call other pieces of software, algorithms, application programming interfaces (APIs), graphical user interfaces (GUIs) etc., to operate as discussed herein. The software module 120 can include, be coupled to, and/or represent various pieces of software to operate as described herein.

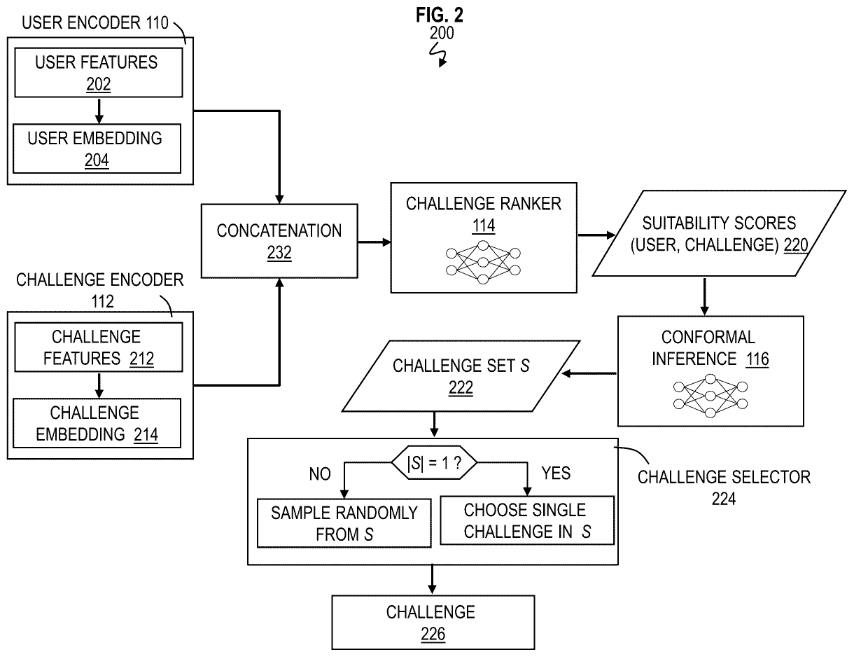

FIG. 2 depicts a flow diagram of a computer-implemented method 200 for dynamically executing an adaptive risk-based challenge system for platform-wide friction management using conformal uncertainty calibration in order to grant or deny access to protected systems in accordance with one or more embodiments. In one or more embodiments, the computer-implemented method 200 can be executed by the computer system 102.

An example scenario may be that the user of user device 140A is requesting access to protected services and/or data, which can be represented by the protected systems 130. The protected systems 130 can represent numerous computer systems 132A-132N (generally referred to as computer systems 132), repositories 134A-134N (generally referred to as repositories 134) of data, networks connecting the systems 132 and repositories 134, etc. In accordance with one or more embodiments, the computer system 102 operates as a security system that grants or denies the request of the user by dynamically modulating the difficulty of the challenge presented to the user on a per-request basis such that users deemed to present a high security risk are presented difficult challenges and user deemed to present a low security risk are presented easy challenges. The users of the user devices 140 represent actors or entities attempting to gain access to protected systems. In some cases, the actor may be a human user desiring to access the protected systems 130 for normal activities within the policies and guidelines as outlined by the organization providing the protected systems 130. In other cases, the actor may be a human or bot (e.g., piece of automated software) attempting to access the protected systems for abnormal and/or malicious activities outside of the policies and guidelines prescribed by the organization providing the protected systems 130, which can present a cybersecurity issue. Although an example scenario is provided, it should be appreciated that the example scenario is for illustration purposes and is not meant to limit embodiments. Reference can be made to any figures discussed herein.

In one or more embodiments, the user encoder 110 receives user features 202 and generates, responsive to receiving the user features 202, a user embedding 204. User features 202 refer to the set of attributes and data points that characterize a user of the user device 140 requesting access to the protected systems 130. These user features 202 capture various aspects associated with the user and the user device 140. Examples of user features 202 can include IP address, media access control (MAC) address, IP address patterns, account history, geographic location, user demographics (e.g., associated with the user device), user device behavior, and the like. In one or more embodiments, a risk score of the user of the user device 140 can be included as one of the user features 202. In one or more embodiments, the risk score may not be included as one of the user features 202 because the (same or almost the same) features utilized to determine the risk score are present in the user features 202, thereby allowing the risk score to be intrinsically determined.

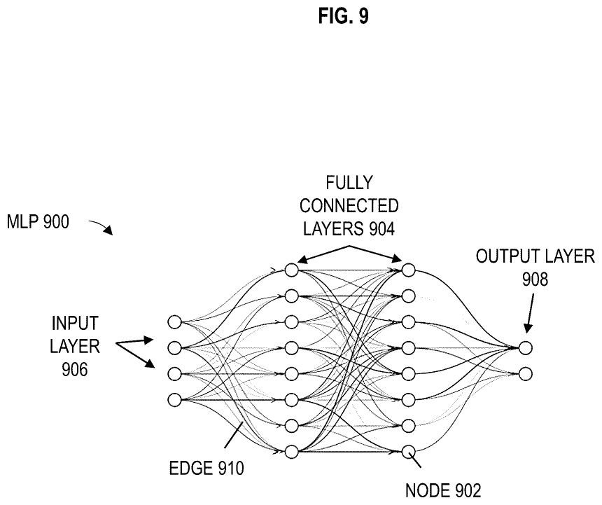

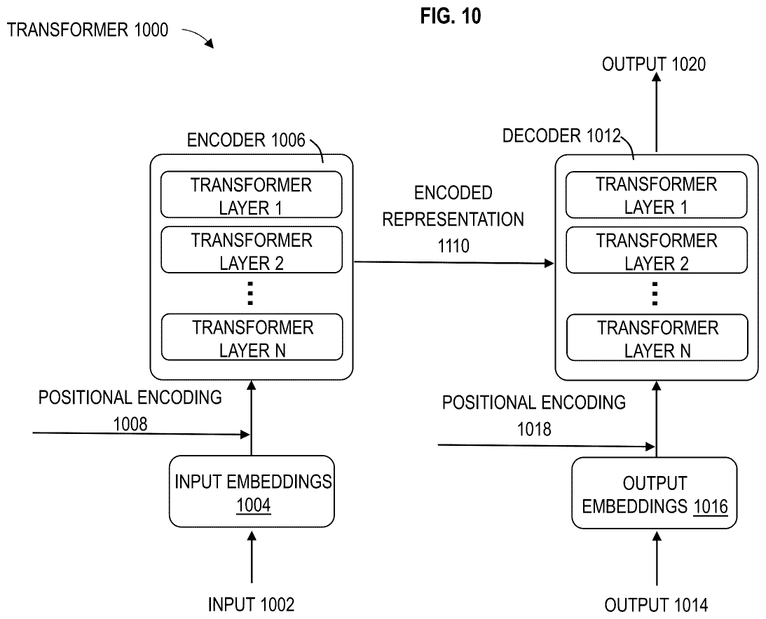

The user embedding 204 refers to a vector representation of the user features 202, capturing the characteristics and behavior of the user and user device 140 in a format that can be used by machine learning models. This embedding is generated by processing the user features 202 through the user encoder 110. Encoders are components used in machine learning to transform raw input data into a different format or representation, thereby making the transformed data suitable for analysis and processing by machine learning models. The user encoder 110 is not meant to be particularly limited, but can include, for example, a neural network encoder, a transformer encoder, an autoencoder, an embedding layer, and/or a feature aggregator. A neural network model, such as a multilayer perceptron (MLP) or a recurrent neural network (RNN), processes input features (e.g., user features 202) through multiple layers to generate an output embedding (e.g., user embedding 204). FIG. 9 illustrates an example MLP configuration. A transformer-based model uses self-attention mechanisms to process user features. This type of encoder can capture long-range dependencies and contextual information, making it suitable for handling diverse and complex recipient data. FIG. 10 illustrates an example transformer configuration. An autoencoder compresses user features 202 into a lower-dimensional representation (e.g., the user embedding 204) and then reconstructs the original features. The compressed representation captures the most important information about the user. A relatively simple embedding layer can map categorical user features to dense vector representations. This layer can be used in combination with other types of encoders to generate a comprehensive user embedding 204. A feature aggregator can aggregate various user features into a single vector representation. This aggregation can be done using techniques like averaging, concatenation, or weighted summation, as desired.

Referring to FIG. 2, in one or more embodiments, the challenge encoders 112 receive challenge features 212 and generate, responsive to receiving the challenge features 212, challenge embedding 214. The challenge embedding 214 can be generated using an encoder in a similar manner as discussed with respect to the user embedding 204. The challenge features 212 refer to the set of attributes and data points that characterize a challenge, in a similar manner as the user features 202 refer to the characteristics of the user and user device 140. These challenge features 212 capture various aspects of each available challenge presented on the underlying network or platform and whether that challenge was successfully solved (e.g., passed) by a user or not (e.g., failed). Examples of challenge features 212 can include the number of times this challenge has been completed successfully (e.g., passed) in the last N days, the number of times this challenge has been failed in the last N days, the challenge type (e.g., CAPTCHA, 2FA, question, etc.), time to completion (e.g., the average time users take to complete the challenge, which can indicate its complexity or user-friendliness), success rate (e.g., the percentage of user who successfully complete the challenge, which provides insight into its difficulty), failure rate (e.g., percentage of users who fail the challenge, which can help in assessing its deterrent effect on unauthorized access), historical context (e.g., data on how the challenge has performed in different contexts or with different user demographics), etc.

A software module 120 receives the respective outputs (embeddings) from the user encoder 110 and the challenge encoder 112 and generates, in response, a concatenation 232. The software module 120 generates the concatenation 232 from the respective outputs (embeddings) from the user encoder 110 and the challenge encoder 112 and feeds this concatenation 232 to the challenge ranker model 114. For example, the user embedding 204 output from the user encoder 110 and the challenge embedding 214 output from the challenge encoder 112 can be vector embeddings and these embeddings can be concatenated to generate the concatenation 232. The challenge ranker model 114 receives input of the user embedding 204 and the challenge embedding 214 as the concatenation 232.

The challenge ranker model 114 can be implemented using various machine learning architectures, such as neural networks (e.g., MLPs, RNNs, deep learning networks, etc.), transformer models, classifier models (e.g., support vector machines, logistic regression, decision trees, K-nearest neighbors, XGBoost, neural networks, etc.), and/or other advanced ML architectures. The choice of architecture depends on the complexity and nature of the input features and the desired prediction accuracy.

In one or more embodiments, the challenge ranker model 114 is trained on labeled training data using, in part, historical data of user features 202 of users and challenge features 212 of challenges. In order to label requests for the user, the system utilizes some measure of riskiness (e.g., risk score) of the user device 140 of a user. In accordance with one or more embodiments, the present disclosure may receive the risk score from a standalone registration risk model. Such a standalone registration risk model assigns each user a risk score, ranging from 0 to 1, based on a variety of factors including user features 202.

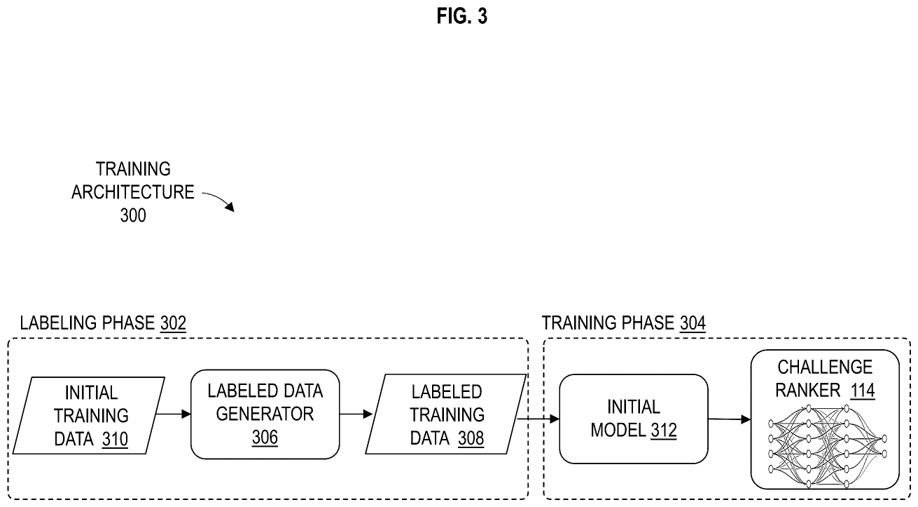

A higher risk score for a user signals a higher risk of future suspicious behavior or non-compliant actions when granted access to protected systems, while a low risk score for a user signals future normal behavior or compliant actions. When a user receives a challenge, the system observes whether the user completes it. A response variable records this outcome: 1) For risky users (e.g., high risk score or restricted), a failure to submit or complete the challenge is recorded as 1 (e.g., indicating that the challenge successfully deterred a potentially suspicious user), while a successful completion is recorded as 0 (e.g., indicating a bad selection of a challenge was sent to a high-risk user because the system seeks to deter risky users). 2) For non-risky users (e.g., low risk score or currently non-restricted), a successful challenge completion is recorded as 1 (e.g., indicating that the challenge did not block a legitimate user), while failure or abandonment is recorded as 0 (e.g., indicating that a bad selection of a challenge was sent to a low-risk user because the system seeks to allow low risk users). Training the challenge ranker model 114 is discussed in greater detail with respect to FIGS. 3, 4, and 5.

During an inference phase, in response to the user embedding 204 and the challenge embedding 214, the challenge ranker model 114 can generate suitability scores 220 for the challenges such that each different challenge has its own suitability score for that user (e.g., which can be a high security risk user or a low security risk user). Each challenge has its own suitability score for that user, which results in suitability scores for user-challenge pairs. The suitability score is an indication of how suitable the (particular) challenge is for the (particular) user, which is the suitability score for that user-challenge pair.

Over time, the system collects data on user responses to various challenges and uses this information to build a challenge ranker model 114 (e.g., classification model). In one or more embodiments, for each user-challenge pair, the challenge ranker model 114 produces a suitability score between 0 and 1, where a higher score indicates a more suitable challenge for that user. This approach enables the challenge ranker model 114 to learn which challenges are most effective for different user profiles (e.g., user features 202), helping to ensure that high-risk users face appropriately difficult challenges while low-risk users experience minimal friction or easy challenges. By rewarding failures for risky users and successes for non-risky users, the challenge ranker model 114 learns to assign challenges that prevent risky users from easily bypassing verification, while allowing genuine users to proceed smoothly.

According to one or more embodiments, the software module 120 is configured to rank the available challenges by suitability scores for the user. The software module 120 can rank the user-challenge pairs by suitability scores. In some embodiments, the challenges (or user-challenge pairs) can be ranked from highest to lowest or from lowest to highest.

In one or more embodiments, in response to the suitability scores 220 being input to the conformal inference model 116, the conformal inference model 116 generates a challenge set 222 (S) which as a set of challenges for the user. Conformal inference using the conformal inference model 116 provides a statistical framework to quantify uncertainty, allowing the system to create a set of potential challenges (e.g., challenge set 222) with a high, user-specified probability 1−α such that one of the challenges in the challenge set 222 is to be suitable for the user. That is, if there are 10 challenges, the conformal inference model 116 can select a subset of three challenges (e.g., S=3) such that the subset of challenges contains a suitable challenge with a probability of 90% (1−α=0.9 (or 90%)).

The conformal wrapper, for each user, creates a set of challenges given a desired confidence level (e.g., 90%), ensuring that this challenge set 222 contains at least one suitable challenge for the user with a confidence level that the operator can select. Here, a suitable challenge (or suitability) is defined as a challenge that the user is likely to solve if they are low risk or fail if they are high risk. Accordingly, the challenge set 222 contains, with a probability 1−α (e.g., 90%), a suitable challenge that the low-risk user is likely to solve or that the high-risk user is likely to fail.

In one or more embodiments, in response to the challenge set 222 being input to the challenge selector 224, the challenge selector 224 selects one challenge 226 from the challenge set 222 to send to the user. The challenge selector 224 is configured to execute a selection algorithm that performs the following: 1) If (YES) the challenge set has one challenge in it, send that (single) challenge to the user. 2) If the challenge set has more than one challenge in it, send one of the challenges from the set at random to the user.

Accordingly, if the challenge set 222 has a single challenge, then the system knows with a probability greater than 1−α that the particular challenge is suitable for the user. Because 1−α is likely be close to 1 (e.g., 100%), the system can send this challenge with high confidence. When the set (e.g., challenge S) has size larger than 1, the selection algorithm of the challenge selector 224 provides a way to intelligently explore the landscape of available challenges. Instead of assigning any of the available challenges at random, the challenge selector 224 assigns from the small challenge set 222 (e.g., generated by the conformal inference model 116) that contains a suitable challenge with a high probability. The results of this data-efficient exploration can be used to retrain or update the challenge ranker model 114 over time.

The computer system 102 is configured to send the challenge 226 to the user device 140. In one or more embodiments, the software module 120 is configured to send the challenge 226 to the user device 140. The software module 120 (and/or the sending of the challenge 226) causes the user device 140 to render the challenge to the user. In one or more embodiments, audio, video, graphic display, holographic display, and/or any combination can be utilized by the user device 140 to render or present the challenge 226 to the user, which allow the user to perform one or more actions as a user response to solve the challenge 226. In response to the user of the user device 140 providing a user response, the computer system 102 is configured to determine whether the challenge 226 is correctly solved (e.g., passed) or incorrectly solved (e.g., failed). In response to failing the challenge 226, the computer system 102 is configured to deny the user access to the protected systems 130. In response to passing the challenge 226, the computer system 102 is configured to grant the user access to the protected systems 130. In one or more embodiments, the software module 120 is configured to determine whether the challenge 226 is correctly solved or not and cause access to the protected systems 130 to be granted (e.g., when correctly solved) or denied (e.g., when incorrectly solved).

FIG. 3 depicts a block diagram of a training architecture 300 for labeling data and training a model to predict suitability scores for the challenges such that each challenge has its own suitability score for a given user (e.g., which can be a high security risk user or a low security risk user), resulting in suitability scores for user-challenge pairs in accordance with one or more embodiments. As shown in FIG. 3, training architecture 300 includes a labeling phase 302 and a training phase 304.

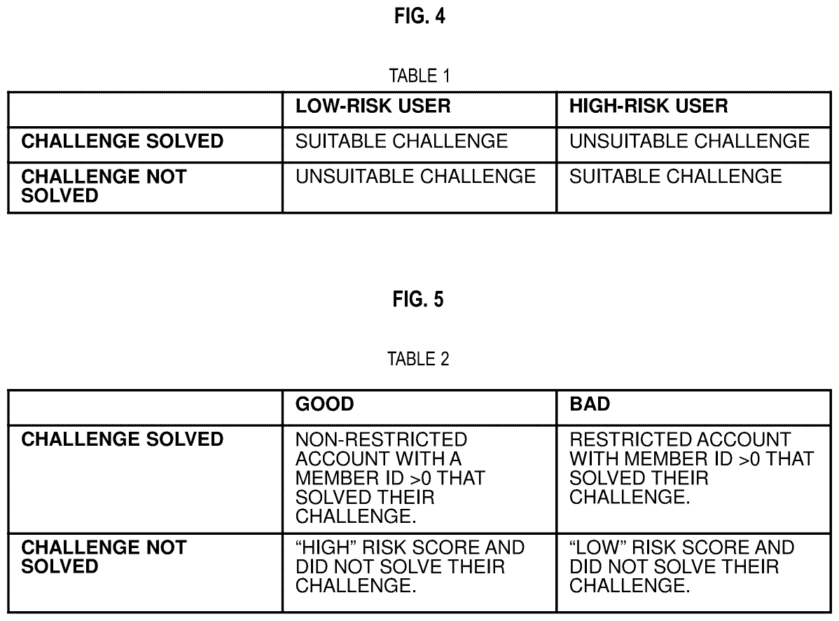

During labeling phase 302, a labeled data generator 306 and/or a subject matter expert can generate labeled training data 308 from initial training data 310 in accordance with a procedure that follows Table 1 in FIG. 4 and Table 2 in FIG. 5. In one or more embodiments, the labeled data generator 306 can include an algorithm configured to generate labeled training data 308 from initial training data 310. The initial training data 310 refers to the dataset used as the starting point for training the challenge ranker model 114. In some embodiments, initial training data 310 includes the challenge presented to the given user, a response variable, a difficulty (e.g., a rating from 0-1) of the challenge presented to the given user, a type of the challenge, user features 202 for the given user, an indication of whether the given user was removed from the platform, etc. The user features 202 include IP address, media access control (MAC) address, IP address patterns, account history, geographic locations, user demographics (e.g., associated with the user device), user device behaviors, risk scores, and the like for the given user and user device. Each user (and user device) has user features 202.

Additionally, the initial training data 310 includes initial positive and negative labels of the form [low-risk user, label] and [high-risk user, label], where a low-risk user refers to a low security risk user and a high-risk user refers to a high security risk user. The security risk of the users refers to the actions expected by the user once the user gains access to, for example, the protected systems 130. As noted herein, a low security risk user is expected to follow the guidelines and policies associated with being granted access to the protected systems. A high security risk user is expected not to follow the guidelines and policies associated with being granted access to the protected systems. With historical data, the system knows the behavior of the users, for example, whether the user performed actions that followed the guidelines and policies thereby remaining on the platform, or whether the user performed actions that failed to follow the guidelines and policies thereby being removed from the platform. In order to label the historical data, the logic of the labeled data generator 306 has to have a designation of what constitutes a suitable challenge for a given user, and Table 1 in FIG. 4 is utilized as a guide. As used herein, a positive label can take on a different meaning depending on whether the user is a low security risk user having a low security risk or a high security risk user having a high security risk, and this distinction is discussed with respect to Tables 1 and 2.

As depicted in Table 1 of FIG. 4, a positive label corresponds to a suitable challenge solved by a low security risk user or a suitable challenge not solved by a high security risk user. Also, as depicted in Table 1, a negative label corresponds to an unsuitable challenge not solved by a low security risk user or an unsuitable challenge being solved by a high security risk user. For example, when a user receives a challenge, the system observes whether the user successfully completes it or not as the response variable. As discussed above, a response variable records this outcome: 1) For risky users (e.g., high risk score or restricted), a failure to submit or complete the challenge is recorded as 1 (e.g., indicating that the challenge successfully deterred a potentially suspicious user), while a successful completion is recorded as 0 (e.g., indicating a bad selection of a challenge was sent to a high-risk user because the system seeks to deter risky users). 2) For non-risky users (e.g., low risk score or currently non-restricted), a successful challenge completion is recorded as 1 (e.g., indicating that the challenge did not block a legitimate user), while failure or abandonment is recorded as 0 (e.g., indicating that a bad selection of a challenge was sent to a low-risk user because the system seeks to allow low risk users).

Table 1 provide logic for generating positive and negative labels when challenges are passed or failed by low security risk users and high security risk users. There can be additional scenarios such as when the challenge is not solved at the registration process to utilize the platform, and the system may not have a reliable way of determining the low security risk status or high security risk status of the user, because the user did not have an opportunity to subsequently interact with the platform to show himself/herself as a compliant or non-compliant actor. Accordingly, the labeling logic of the labeled data generator 306 is configured with a heuristic in the second row of Table 2, which outlines how to determine whether a user, who never had the opportunity to complete registration for the platform, is to be labeled with a positive label or negative label. The second row of Table 2 addresses the case in which the user did not complete registration because the challenge could not be initially solved by the user (e.g., the user failed the challenge). As a result, the user who fails to register does not have historical data (e.g., indicating whether the user performed actions that followed the guidelines and policies thereby remaining on the platform, or whether the user performed actions that failed to follow the guidelines and policies thereby being removed from the platform). Therefore, in such a scenario, the second row of Table 2 acts as a heuristic about how to label the challenge presented to the user in the absence of such historical data, as discussed further below.

As seen in the first row of Table 2 of FIG. 5, a positive label is generated when a suitable challenge is solved by a low security risk user because the user (e.g., as subsequently determined) has a non-restricted account with a member identification; this is considered good. A negative label is generated when an unsuitable challenge (e.g., too easy in this case) is solved by a high security risk user because the user (e.g., as subsequently determined) has a restricted account with a member identification; this is considered bad.

In the second row of Table 2, when the challenge is not solved and therefore the user was not able to register to the platform, a negative label is generated when the user had a low risk score and was unable to register; this means that the user is deemed a low security risk user who was presented an unsuitable challenge. This is considered bad. In the second row of Table 2, when the challenge is not solved and therefore the user was not able to register to the platform (e.g., there is no historical data about how the user interacted with the platform), a positive label is generated when the user had a high risk score and was unable to register; this means that the user is deemed a high security risk user who was presented a suitable challenge. This is considered good.

During training phase 304, an initial model 312 is trained on the labeled training data 308 to generate the challenge ranker model 114. In some embodiments, the initial model 312 processes the labeled training data 308 through one or more layers, for example, using a machine learning architecture such as a neural network, transformer, or other advanced models, to identify patterns and relationships within the labeled training data 308 that are indicative of a suitability score per challenge for users. In some embodiments, parameters of the initial model 312 are initialized (randomly or to predetermined parameters learned from prior training phases for the current or any prior model) and adjusted iteratively to minimize a loss function, which quantifies the difference between the predicted suitability scores and the actual low security risk/high security risk users observed in the labeled training data 308. Loss functions used in this context can include cross-entropy loss and mean squared error (MSE).

Throughout the training process, techniques such as backpropagation and gradient descent can be employed to update the internal parameters of the initial model 312, such as the weights and biases of one or more layers, thereby gradually improving its predictive accuracy. The training phase may also involve techniques like regularization to prevent overfitting, ensuring that resultant challenge ranker model 114 generalizes well to new, unseen data. Additionally, the training process may include validation steps, where a portion of the labeled training data 308 is set aside to evaluate the performance and fine-tune the hyperparameters of the challenge ranker model 114.

Once the training phase 304 is complete, the resulting challenge ranker model 114 is capable of generating suitability predictions for available challenges for a given user. During inference, a suitability score is provided for each available challenge for the given user, thereby resulting in an individual suitability score for each user-challenge pair. These predictions of suitability scores are used to determine which challenge to send to a user according to the riskiness of the user as discussed herein, such that a high security risk user is presented with a difficult challenge while a low security risk user is presented with an easy challenge. During the inference phase, the user features 202 for a user are utilized by the challenge ranker 114 to determine when the user is a low security risk user or a high security risk user.

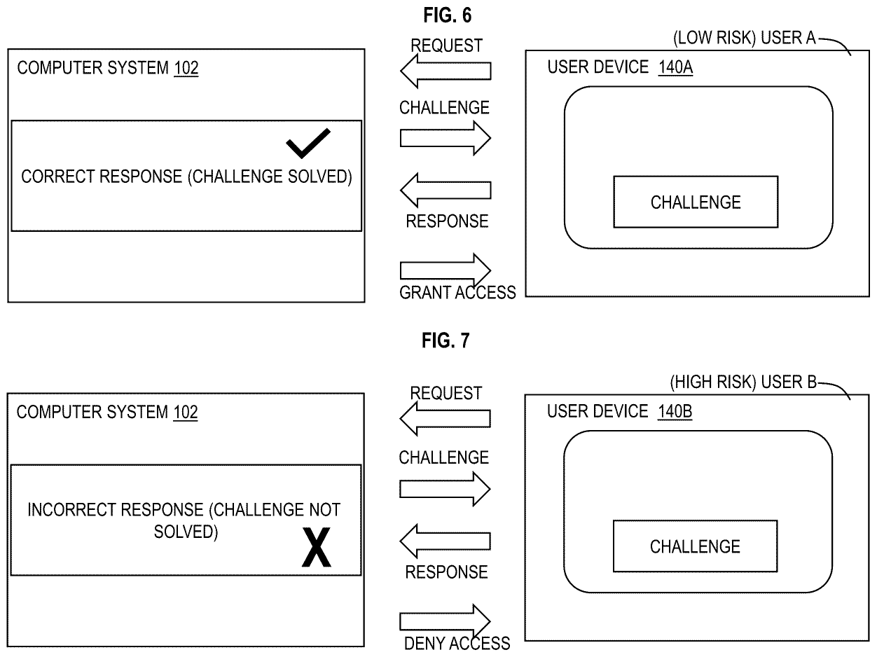

FIG. 6 depicts a block diagram of a low security risk user requesting access to digital resources such as services and/or protected data associated with the protected systems 130. In this case, the computer system 102 receives a request from the user device 140A of a low security risk user depicted as user A. As discussed herein, the computer system 102 determines a suitable challenge (e.g., an easy challenge, or maybe no challenge) for user A and sends the challenge to user device 140A, which causes the challenge to be presented on the user device 140A of user A. In response, the user device 140A sends a response to the challenge. In this example, the computer system 102 (e.g., with the help of one or more computer systems or software module 120) determines that the challenge is solved, which means that user A passed the challenge. Accordingly, the computer system 102 approves the request and grants access to the requested service and/or data, for example, of the protected systems 130. In one or more embodiments, the computer system 102 can communicate with and cause one or more computer systems to grant access to the requested service and/or data.

On the other hand, FIG. 7 depicts a block diagram of a high security risk user requesting access to digital resources such as services and/or protected data associated with the protected systems 130. In this case, the computer system 102 receives a request from the user device 140B of a high security risk user depicted as user B. As discussed herein, the computer system 102 determines a suitable challenge (e.g., a difficult challenge) for user B and sends the challenge to user device 140B, which causes the challenge to be presented on the user device 140B of user B. In response, the user devices 140B sends a response to the challenge. In this example, the computer system 102 determines that the challenge is not solved, which means that user B failed the challenge. Accordingly, the computer system 102 denies the request and denies access to the requested services and/or data, for example, of the protected systems 130.

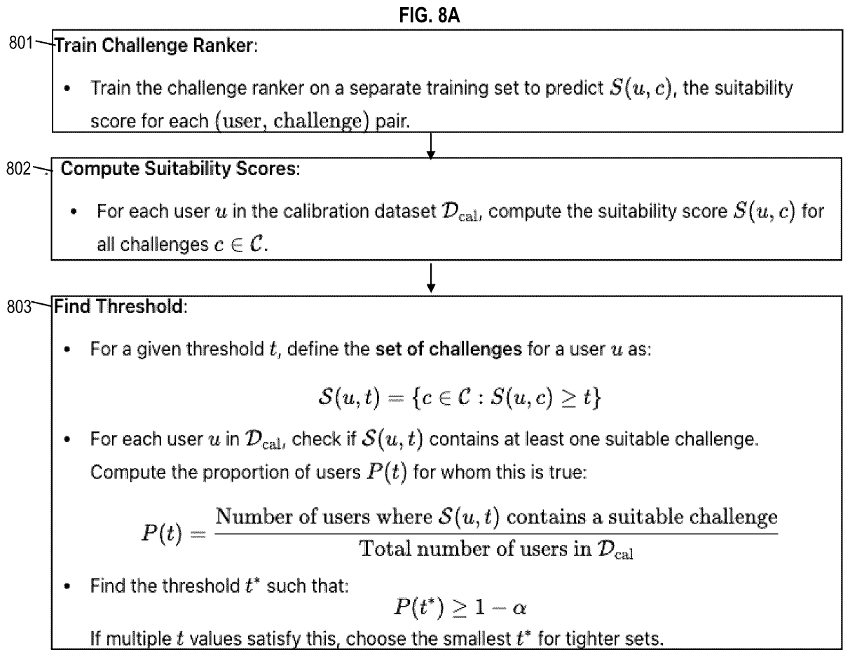

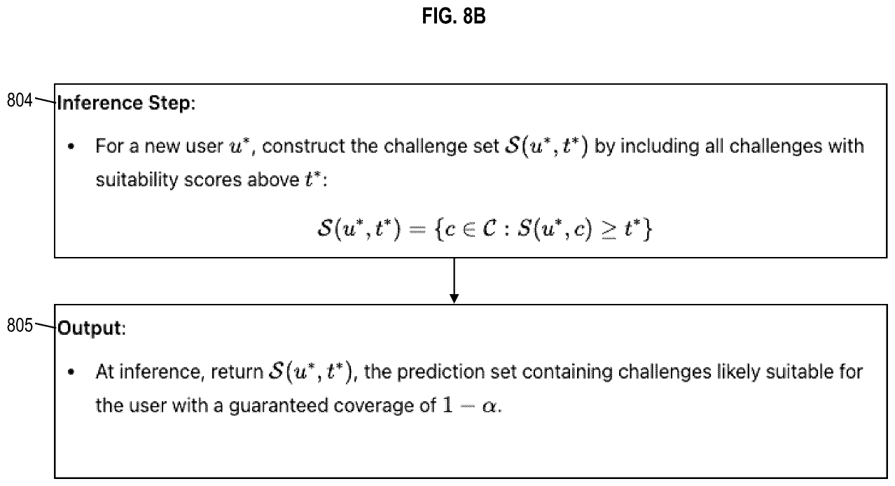

Turning to example details regarding the conformal calibration for the conformal inference model 116, FIGS. 8A and 8B depict an example procedure in accordance with one or more embodiments. The goal of the conformal calibration is to identify a threshold for suitability scores such that, for 1−α of challenges in the calibration set, the constructed challenge set contains at least one suitable challenge. This threshold is used to construct the challenge set at inference.

The input is as follows:
D_{cal}: Calibration data set consisting of (user, challenge, label).
model (·): Pre-trained challenge ranker that outputs suitability scores S(u, c).
α: Significance level (1−α is the desired coverage).
C: Set of all available challenges.

As seen in FIGS. 8A and 8B, the procedure trains the challenge ranker model 114 to predict suitability scores for each (user, challenge) pair at block 801. At block 802, the challenge ranker model 114 generates suitability scores for each user u in the calibration data set. At block 803, the procedure finds the threshold t and the find the threshold t* where the probability of finding t* is greater than or equal to 1−α. At block 804, the procedure performs the inference step of, for a new user u*, constructing the challenged set S(u*, t*) by including all challenges with a suitability score above t*. For example, the suitable scores for the available challenges are ranked (e.g., from highest to lowest), and challenges having a suitability score above the threshold t* (e.g., a suitability threshold) are selected for the challenge set S (e.g., challenge set 222). At block 805, the procedure, at inference, outputs the prediction set containing challenges likely suitable for the user with a guaranteed coverage of 1−α.

FIG. 9 depicts a block diagram of an example a multilayer perceptron (MLP) 900 in accordance with one or more embodiments. In one or more embodiments, one or more of the models (e.g., challenge ranker model 114, conformal inference model 116, etc.) previously described can be implemented in whole or in part as the MLP 900, which is a type of feedforward artificial neural network that consists of multiple layers of interconnected nodes 902. In this implementation, the MLP 900 includes one or more fully connected layers 904 using input (e.g., user features 202, challenges features 212, suitability scores for user-challenges pairs, etc.) (collectively defining an input layer 906). In this type of implementation, the output layer 908 can include a suitability score for a challenge for a given user (e.g., user-challenge pair) output from the challenge ranker model 114 or a challenge set (e.g., challenge set S) output from the conformal inference model 116, etc., depending on the underlying system being implemented. The depth, width, dimensionality, etc., of the MLP 900 need not be particularly limited, and the construction shown in FIG. 9 is merely illustrative.

In some embodiments, MLP 900 includes one or more nodes 902 (neurons) arranged in each of the fully connected layers 904. Nodes 902 in adjacent fully connected layers 904 are connected by weighted edges 910, where the weight of a respective edge represents the strength of the connection between the respective nodes 902. These weights are adjusted during the learning process. In some embodiments, each node 902 in the MLP 900 performs a weighted sum of its inputs, adds a bias term, and then, optionally, applies a non-linear activation function to produce an output. The nonlinear activation function, such as a rectified linear unit (ReLU), sigmoid, or tanh function, can be applied to the outputs of each node 902 to introduce nonlinearity, allowing the MLP 900 to learn more complex notification disinterest patterns.

Turning now to FIG. 10, in one or more embodiments, one or more of the models (e.g., challenge ranker model 114, conformal inference model 116, etc.) previously described can be implemented in whole or in part using a transformer 1000, such as those relied upon in some large language models (LLMs). In some embodiments, transformer 1000 includes an encoder 1006 trained to generate embeddings (e.g., user embedding 204, challenge embedding 214, etc.). While not meant to be particularly limited, the transformer 1000 and/or encoder 1006 can include a neural network machine learning architecture that is capable of processing large amounts of text data and generating high-quality natural language responses. In practice, large language models have been used for a wide range of natural language processing (NLP) tasks, including, for example, machine translation, text generation, sentiment analysis, and question answering (i.e., query-and-response). Large language models have also been adapted for other domains, such as computer vision, speech recognition, and software development.

At its core, a large language model consists of an encoder and a decoder. The encoder takes in a sequence of input tokens, such as words or characters, and produces a sequence of hidden representations for each token that capture the contextual information of the input sequence. The decoder then uses these hidden representations, along with a sequence of target tokens, to generate a sequence of output tokens.

The most popular and widely used types of large language models are recurrent neural networks (RNNs) and transformers. RNNs are neural networks that process sequences of inputs one by one and use a hidden state to remember previous inputs. RNNs are particularly well-suited for tasks that involve sequential data, such as text, audio, and time-series data. In a transformer, on the other hand, the encoder and decoder are composed of multiple layers of multi-headed self-attention and feedforward neural networks. The core of the transformer model is the self-attention mechanism, which allows the model to focus on different parts of an input sequence at different timesteps, without the need for recurrent connections that process the sequence one by one. Transformers leverage self-attention to compute representations of input sequences in a parallel and context-aware manner and are well-suited to tasks that require capturing long-range dependencies between words in a sentence, such as in language modeling and machine translation.

Large language models are typically trained on large amounts of text data, often containing hundreds of millions if not billions of words. To handle the large amount of data, the training process is often highly parallelized. The training process can take several days or even weeks, depending on the size of the model and the amount of training data involved. Large language models can be trained using backpropagation and gradient descent, with the objective of minimizing a loss function such as cross-entropy loss.

As shown in FIG. 10, the transformer 1000 begins with an input 1002. The input 1002 denotes an input provided by a user (or upstream system) and can be represented as a sequence of tokens, individual words or sub-words, from which input embeddings 1004 can be generated. The input embeddings 1004 represent the tokens within the input 1002 as numbers, which can be processed using encoder 1006. In some embodiments, a positional encoding 1008 can be generated to encode the position of each token in input 1002 as a set of numbers. These numbers can be fed into the encoder 1006 with the input embeddings 1004, allowing the transformer-based architecture to more effectively understand the order of words in a sentence and to thereby generate grammatically correct and semantically meaningful outputs.

The encoder 1006 processes the input embeddings 1004 and the positional encoding 1008 and generates, for the input 1002, an encoded representation 1010 (in various implementations, the user embedding 204, challenge embedding 214, etc.) that captures the meaning and context of the input 1002. To accomplish this, encoder 1006 applies a series of self-attention transformer layers (or simply, “transformer layers”), which are a series of hidden states that represent the input 1002 at different levels of abstraction. The encoder 1006 can include any number of these transformer layers, as desired. In some embodiments, the encoded representation 1010 is provided to a decoder 1012.

The decoder 1012 similarly includes a number of transformer layers, as desired, except that the decoder 1012 processes an output 1014. In most implementations, the output 1014 is a right-shifted copy of the input 1002, meaning that the decoder 1012 can only use the previous words for next-token prediction. In some embodiments, output embeddings 1016 can be generated from the output 1014 to represent the tokens in the output 1014 as numbers, in a similar manner as described with respect to the encoder 1006. A positional encoding 1018 can be added to the output embeddings 1016 to encode the position of each token in output 1014 as a set of numbers. The decoder 1012 can be trained by minimizing a loss function (also known as an objective function, which quantifies a difference between a predicted output and a known true value) using, for example, gradient descent. Once trained, the transformer 1000 can be used during an inference phase to generate an output 1020, which can be thought of as a next-token probability (that is, how likely is the next token in the sequence to be x, or y, etc.). In some configurations, the transformer-based architecture includes a linear layer and SoftMax layer (omitted for clarity) to transform a raw output from the decoder 1012 into the output 1020. For example, after the decoder 1012 produces a raw output (e.g., output embeddings), the linear layer can map the output embeddings to a higher-dimensional space, thereby transforming the output embeddings into a same original input space as the input 1002. The SoftMax function can be used to generate a probability distribution for each output token in the vocabulary in order to generate output tokens with probabilities (e.g., the output 1020).

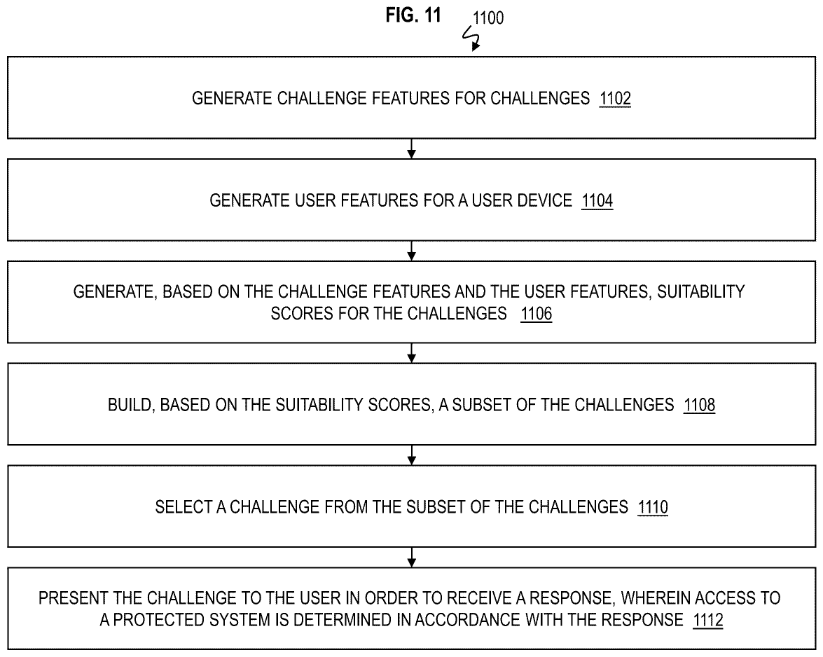

FIG. 11 depicts a flowchart of a computer-implemented 1100 adaptive risk-based challenge system for platform-wide friction management using conformal uncertainty calibration according to one or more embodiments. The method 1100 is described with reference to FIGS. 1 to 12 and may include additional steps not depicted in FIG. 11. Although depicted in a particular order, the blocks depicted in FIG. 11 can be, in some embodiments, rearranged, subdivided, and/or combined. In one or more embodiments, the method 1100 may be executed by one or more computer systems 102 on behalf of a user of a user device 140.

At block 1102, the method 1100 includes generating challenge features (e.g., challenge features 212) for challenges (e.g., the available challenges). In one or more embodiments, the challenge encoder 112 is configured to generate challenge features 212 (and their corresponding challenge embedding 214) for the available challenges.

At block 1104, the method 1100 includes, during an inference phase, generating user features (e.g., user features 202) for a user. In one or more embodiments, the user encoder 110 is configured to generate user features 202 (and their corresponding user embedding 204) for the user.

At block 1106, the method 1100 includes generating, based on the challenge features and the user features, suitability scores (e.g., suitability scores 220) for the challenges. In one or more embodiments, the challenge ranker model 114 is configured to generate the suitability scores 220.

At block 1108, the method 1100 includes building, based on the suitability scores, a subset (e.g., challenge set S) of the challenges where the subset of the challenges is selected to meet a suitability threshold (e.g., threshold t*). The conformal inference model 116 is configured to build the challenge set 222, according to one or more embodiments.

At block 1110, the method 1100 includes selecting a challenge (e.g., challenge 226) from the subset (e.g., challenge set S) of the challenges. In one or more embodiments, the challenge selector 224 is configured to select the challenge 226.

At block 1110, the method 1100 include presenting the challenge to the user (e.g., user device 140) in order to receive a response, where access to a protected system (e.g., protected systems 130) is determined in accordance with the response. In one or more embodiments, the software module 120 is configured to present and/or cause the challenge 226 to be presented on the user device 140.

According to one or more embodiments, the method can include, during a training phase, training a challenge ranker (e.g., challenge ranker model 114) to output the suitability scores for the challenges based on the challenge features and the user features.

Training the challenge ranker includes dynamically labeling training data (e.g., initial training data 310) as positive labels and negative labels; the positive labels are assigned to first challenges that were passed by a first class of users (e.g., compliant users or low security risk users) and failed by a second class of users (e.g., non-compliant users or high security risk users); the negative labels are assigned to second challenges that were failed by the first class of users (e.g., compliant users or low security risk users) and passed by the second class of users (e.g., non-compliant users or high security risk users); and during the training phase, the challenge ranker is trained to generate the suitability scores for the first challenges and the second challenges for the first class of users and the second class of users, respectively. Advantageously, this training technique allows the challenge ranker model 114 to learn the compliant and non-compliant users while accounting for their respective challenges and responses in the positive and negative labels.

In one or more embodiments, the first class of users are associated with a low security risk and the second class of users are associated with a high security risk.

According to one or more embodiments, in response to the subset including a number of the challenges greater than a predetermined threshold, the subset of the challenges with associated responses is used as training data to further train the challenge maker.

In one or more embodiments, selecting the challenge from the subset of the challenges includes: in response to a number of the challenges in the subset being greater than one (e.g., |S|>1), selecting the challenge from the subset at random; and in response to the number of the challenges in the subset being equal to one (e.g., |S|=1), selecting one challenge in the subset.

According to one or more embodiments, the user features include attributes related to the user attempting to gain the access to the protected system (e.g., protected systems 130).

Further, as technical solutions and benefits, one or more embodiments develop an adaptive challenge assignment system that optimally balances security and usability. The present disclosure strategically transforms this complex matching task into a classification problem where user-challenge interactions are analyzed, generating suitability scores that ultimately guide optimal challenge assignment that is sent to the user in order to grant or deny access to a protected system.

As technical solutions and benefits, the innovative use of the conformal calibration of the conformal calibration model enables efficient, data-driven exploration for any black box classification system by creating prediction sets for each user with a specified confidence level. According to one or more embodiments, the conformal calibration model narrows challenge selection to options where the conformal calibration model cannot confidently distinguish suitability, allowing the conformal calibration model to focus exploration on challenges where it is most uncertain among potentially suitable options. The conformal calibration process guarantees that each prediction set contains at least one challenge with a high probability of achieving the intended outcome, which is either blocking high-risk users or allowing low-risk users to pass. By integrating conformal inference, the system provides a statistically robust method for dynamically adapting challenge assignments, continuously refining its choices based on real-time data. This innovation achieves an optimal balance between deterring potentially malicious users and minimizing friction for legitimate users, creating a highly adaptive and efficient approach to secure user registration.

As technical solutions and benefits, the adaptive user challenge system provides a practical balance between security and user experience, addressing unique challenges for any online platform such as, for example, social media platforms, professional networking sites, electronic transaction platforms, cloud and collaboration services, gaming and streaming services, etc. By dynamically adjusting the difficulty of verification challenges based on a user's risk profile (which can be implicit based on user features (without an explicit risk score) and/or explicit based on a risk score being in the user features), one or more embodiments can streamline interaction of legitimate users while blocking potential malicious actors. This system can play a pivotal role in enhancing platform trust, thereby sustaining credibility and maintaining security.

The system is configured to ensure that new accounts are genuine and free from spam is critical to maintaining a trustworthiness and minimize friction for real user during registration, login, and other sensitive actions, enabling seamless onboarding and frequent interactions. For high-risk users or accounts exhibiting suspicious behavior, the system intensifies security checks, reducing the presence of fake profiles and preventing spammy or abusive activities. Moreover, by reducing manual interventions and thresholds with a data-driven, adaptive approach, the system can lower the utilization of computational operational resources while increasing the efficiency and effectiveness of its security framework. This results in a secure, scalable, and user-friendly platform that continues to support growth, all while improving the user experience.

As further examples of technical solutions and benefits, social media platforms are dealing with fake accounts, spam, and malicious activities. The adaptive security challenge system can be utilized to protect user integrity, control bot proliferation, and enhance account security, particularly during high-risk actions like account recovery or posting privileges. Professional networking sites face similar challenges in onboarding genuine users and maintaining the trustworthiness of their user base. The adaptive security challenge system is a mechanism to ensure high-quality engagement and prevent fake or low-quality profiles from joining the professional network site. For electronic transaction platforms (e.g., E-commerce platforms), these computer systems manage large volumes of financial transactions and user data, making them highly susceptible to fraud. Implementing adaptive verification based on a user's risk profile assists with secure high-value actions like purchases and refunds, while streamlining the experience for trusted users. Also, electronic transaction platforms can integrate adaptive challenges of the adaptive security challenge system for authenticating users during high-risk actions such as large transfers, withdrawals, or new device logins; the system provides seamless security for regular customers while deterring potential fraudsters. Cloud and collaboration services have platforms that manage sensitive files and data managed on these platforms, and adaptive security challenges enhance protection, particularly for shared documents or when new devices access accounts. For gaming and streaming services, these platforms experience frequent bot and spam activity, and adaptive security challenge system is configured to authenticate users based on their behavior and history. For example, they could apply more rigorous checks for high-frequency users or accounts exhibiting unusual behavior.

FIG. 12 illustrates aspects of an embodiment of a computer system 1200 that can perform various aspects of embodiments described herein. In some embodiments, the computer system(s) 1200 can implement and/or otherwise be incorporated within or in combination with any component, module, or model of the system 100 (refer to FIGS. 1-11). In some embodiments, a computer system 1200 can be implemented server-side. For example, a remote computer system 1200 can be configured to receive a candidate notification and to generate, in response, a disinterest prediction.

The computer system 1200 includes at least one processing device 1202, which generally includes one or more processors or processing units for performing a variety of functions, such as, for example, completing any portion of the hybrid meta learning recommendation service 100 described previously. Components of the computer system 1200 also include a system memory 1204, and a bus 1206 that couples various system components including the system memory 1204 to the processing device 1202. The system memory 1204 may include a variety of computer system readable media. Such media can be any available media that is accessible by the processing device 1202, and includes both volatile and non-volatile media, and removable and non-removable media. For example, the system memory 1204 includes a non-volatile memory 1208 such as a hard drive, and may also include a volatile memory 1210, such as random access memory (RAM) and/or cache memory. The computer system 1200 can further include other removable/non-removable, volatile/non-volatile computer system storage media.

The system memory 1204 can include at least one program product having a set (e.g., at least one) of program modules that are configured to carry out functions of the embodiments described herein. For example, the system memory 1204 stores various program modules that generally carry out the functions and/or methodologies of embodiments described herein. A module or modules 1212, 1214 may be included to perform functions related to any of the block diagrams described herein. The computer system 1200 is not so limited, as other modules may be included depending on the desired functionality of the computer system 1200. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 1202 can also be configured to communicate with one or more external devices 1216 such as, for example, a keyboard, a pointing device, and/or any devices (e.g., a network card, a modem, etc.) that enable the processing device 1202 to communicate with one or more other computing devices. Communication with various devices can occur via Input/Output (I/O) interfaces 1218 and 1220.

The processing device 1202 may also communicate with one or more networks 1222 such as a local area network (LAN), a general wide area network (WAN), a bus network and/or a public network (e.g., the Internet) via a network adapter 1224. In some embodiments, the network adapter 1224 is or includes an optical network adaptor for communication over an optical network. It should be understood that although not shown, other hardware and/or software components may be used in conjunction with the computer system 1200. Examples include, but are not limited to, microcode, device drivers, redundant processing units, external disk drive arrays, RAID systems, and data archival storage systems, etc.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the present disclosure are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or” unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Embodiments of the present disclosure may be implemented as or as part of a system, a method, and/or a computer program product at any possible technical detail level of integration. The computer program product may include a computer readable storage medium (or media) having computer readable program instructions thereon for causing a processor to carry out aspects of the present disclosure.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a special purpose computer to produce a machine, such that the instructions, which execute via the processor of the special purpose computer, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method comprising:
generating challenge features for challenges;
generating user features for a user device;
generating, based on the challenge features and the user features, suitability scores for the challenges;
building, based on the suitability scores, a subset of the challenges, wherein the subset of the challenges is selected to meet a suitability threshold;
selecting a challenge from the subset of the challenges; and
presenting the challenge to the user in order to receive a response, wherein access to a protected system is determined in accordance with the response.

2. The method of claim 1, further comprising training a challenge ranker to output the suitability scores for the challenges based on the challenge features and the user features.

3. The method of claim 2, wherein:
training the challenge ranker comprises labeling training data as positive labels and negative labels;
the positive labels are assigned to first challenges that were passed by a first plurality of users and failed by a second plurality of users;
the negative labels are assigned to second challenges that were failed by the first plurality of users and passed by the second plurality of users; and
the challenge ranker is trained to generate the suitability scores for the first challenges and the second challenges for the first plurality of users and the second plurality of users, respectively.

4. The method of claim 3, wherein the first plurality of users are associated with a low security risk and the second plurality of users are associated with a high security risk.

5. The method of claim 2, wherein, in response to the subset comprising a number of the challenges greater than a predetermined threshold, the subset of the challenges with associated responses is used as training data to further train the challenge ranker.

6. The method of claim 1, wherein selecting the challenge from the subset of the challenges comprises:
in response to a number of the challenges in the subset being greater than one, selecting the challenge from the subset at random; and
in response to the number of the challenges in the subset being equal to one, selecting one challenge in the subset.

7. The method of claim 1, wherein the user features comprise attributes related to the user device attempting to gain the access to the protected system.

8. The method of claim 1, wherein:
a challenge ranker is trained to output the suitability scores for the challenges based on the challenge features and the user features;
training data is labeled with positive labels and negative labels;
the positive labels are assigned to first challenges that were passed by a first plurality of users, the first plurality of users having a non-restricted account; and
the negative labels are assigned to second challenges that were passed by a second plurality of users, the second plurality of users having a restricted account.

9. The method of claim 1, wherein:
a challenge ranker is trained to output the suitability scores for the challenges based on the challenge features and the user features;
training data is labeled with positive labels and negative labels;
the negative labels are assigned to first challenges that were not passed by a first plurality of users in which historical data is absent about how the first plurality of users interacted with the protected system, the first plurality of users being associated with a low security risk; and
the positive labels are assigned to second challenges that were not passed by a second plurality of users in which the historical data is absent about how the second plurality of users interacted with the protected system, the second plurality of users being associated with a high security risk.

10. A system comprising a memory, computer readable instructions, and one or more circuitry for executing the computer readable instructions, the computer readable instructions controlling the one or more circuitry to perform operations comprising:
generating challenge features for challenges;
generating user features for a user device;
generating, based on the challenge features and the user features, suitability scores for the challenges;
building, based on the suitability scores, a subset of the challenges, wherein the subset of the challenges is selected to meet a suitability threshold;
selecting a challenge from the subset of the challenges; and
presenting the challenge to the user in order to receive a response, wherein access to a protected system is determined in accordance with the response.

11. The system of claim 10, wherein the operations further comprise training a challenge ranker to output the suitability scores for the challenges based on the challenge features and the user features.

12. The system of claim 10, wherein:
training the challenge ranker comprises labeling training data as positive labels and negative labels;
the positive labels are assigned to first challenges that were passed by a first plurality of users and failed by a second plurality of users;
the negative labels are assigned to second challenges that were failed by the first plurality of users and passed by the second plurality of users; and
the challenge ranker is trained to generate the suitability scores for the first challenges and the second challenges for the first plurality of users and the second plurality of users, respectively.

13. The system of claim 12, wherein the first plurality of users are associated with a low security risk and the second plurality of users are associated with a high security risk.

14. The system of claim 11, wherein, in response to the subset comprising a number of the challenges greater than a predetermined threshold, the subset of the challenges with associated responses is used as training data to further train the challenge ranker.

15. The system of claim 10, wherein selecting the challenge from the subset of the challenges comprises:
in response to a number of the challenges in the subset being greater than one, selecting the challenge from the subset at random; and
in response to the number of the challenges in the subset being equal to one, selecting one challenge in the subset.

16. The system of claim 10, wherein the user features comprise attributes related to the user device attempting to gain the access to the protected system.

17. The system of claim 10, wherein:
a challenge ranker is trained to output the suitability scores for the challenges based on the challenge features and the user features;
training data is labeled with positive labels and negative labels;
the positive labels are assigned to first challenges that were passed by a first plurality of users, the first plurality of users having a non-restricted account; and
the negative labels are assigned to second challenges that were passed by a second plurality of users, the second plurality of users having a restricted account.

18. The system of claim 10, wherein:
a challenge ranker is trained to output the suitability scores for the challenges based on the challenge features and the user features;
training data is labeled with positive labels and negative labels;
the negative labels are assigned to first challenges that were not passed by a first plurality of users in which historical data is absent about how the first plurality of users interacted with the protected system, the first plurality of users being associated with a low security risk; and
the positive labels are assigned to second challenges that were not passed by a second plurality of users in which the historical data is absent about how the second plurality of users interacted with the protected system, the second plurality of users being associated with a high security risk.

19. A computer program product comprising a computer readable storage medium having program instructions embodied therewith, the program instructions executable by one or more circuitry to cause the one or more circuitry to perform operations comprising:
generating challenge features for challenges;
generating user features for a user device;
generating, based on the challenge features and the user features, suitability scores for the challenges;
building, based on the suitability scores, a subset of the challenges, wherein the subset of the challenges is selected to meet a suitability threshold;
selecting a challenge from the subset of the challenges; and
presenting the challenge to the user in order to receive a response, wherein access to a protected system is determined in accordance with the response.

20. The computer program product of claim 19, wherein the operations further comprise training a challenge ranker to output the suitability scores for the challenges based on the challenge features and the user features.
